(19) United States
(12) Patent Application Publication
(10) Pub. No.: US 2019/0204915 A1
(43) Pub. Date: Jul. 4, 2019

(54) WEARABLE INPUT DEVICE, HOST, INPUT METHOD AND ELECTRONIC SYSTEM

(71) Applicants: Beijing BOE Optoelectronics Technology Co., Ltd., Beijing (CN); BOE TECHNOLOGY GROUP CO., LTD., Beijing (CN)

(72) Inventors: Gang CI, Beijing (CN); Hao WU, Beijing (CN); Xuzhong LIU, Beijing (CN); Na AN, Beijing (CN); Baolei GUO, Beijing (CN); Xinfeng GONG, Beijing (CN); Zheng ZHANG, Beijing (CN); Wei SU, Beijing (CN); Zongwei LUO, Beijing (CN); Xiao MA, Beijing (CN); Bin XU, Beijing (CN); Shaopeng XU, Beijing (CN); Zhenhua LUO, Beijing (CN); Qingzhu GUAN, Beijing (CN)

(21) Appl. No.: 16/047,041

(22) Filed: Jul. 27, 2018

(30) Foreign Application Priority Data
Jan. 2, 2018 (CN) 201810001032.1

(51) Int. Cl. G06F 3/01; G06F 3/03; G06F 3/023

(52) U.S. Cl. CPC G06F 3/014; G06F 3/0233; G06F 3/0304

(57) ABSTRACT

The present disclosure relates to a wearable input device, a host, an input method and an electronic system. The wearable input device includes a body, and further includes a detection module, a positioning module, a communication module and a processor which are provided on the body. The detection module is configured to detect whether the body performs a tap action on an operation plane, and send a detection result to the processor; the positioning module is configured to determine a current position of the body on the operation plane, and send the current position to the processor; and the processor is configured to send the current position or a key value calculated according to the current position to a host via the communication module when the body performs the tap action.

### CROSS-REFERENCE TO RELATED APPLICATIONS

This application claims priority to Chinese Patent Application 201810001032.1, filed Jan. 2, 2018, the entire contents of which are incorporated herein by reference.

### TECHNICAL FIELD

The present disclosure relates to smart or intelligent wearable device technical fields and particularly to a wearable input device, a host, an input method and an electronic system.

### BACKGROUND

With the development of society and continuous advancement of electronic technologies, electronic products have increasingly occupied various fields, which in turn has promoted the rapid development of keyboards, important input devices for electronic products. However, conventional keyboards are bulky and inconvenient to carry, and are subject to many constraints when used. In order to change the status quo, a series of portable wearable input devices have emerged. However, the existing wearable input devices have complicated structures and are difficult to operate.

### SUMMARY

Embodiments of the present disclosure provide a wearable input device, a host, an input method and an electronic system, in order to achieve a portable input device which has a simple structure and is convenient to operate.

An embodiment of the present disclosure provides a wearable input device. The wearable device includes a body, and further includes a detection module, a positioning module, a communication module and a processor which are provided on the body.

The detection module is configured to detect whether the body performs a tap action on an operation plane, and send a detection result to the processor;

the positioning module is configured to determine a current position of the body on the operation plane, and send the current position to the processor; and

the processor is configured to send the current position or a key value calculated according to the current position to a host via the communication module when the body performs the tap action.

According to an exemplary embodiment, the positioning module is further configured to determine whether the body has a position change in a direction perpendicular to the operation plane, and send information regarding the position change to the processor; and

the processor is configured to determine, according to the detection result of the detection module and the information regarding the position change, whether the body performs the tap action, and when it is determined that the body performs the tap action, send the current position or the key value calculated according to the current position to the host via the communication module.

According to an exemplary embodiment, the detection module is a light sensor.

According to an exemplary embodiment, the positioning module is a distance sensor, and is configured to obtain a distance from the body to an initial position of the body on the operation plane and determine the current position of the body on the operation plane according to the distance.

According to an exemplary embodiment, the body is a glove-style body, and the detection module and the positioning module are disposed at at least one fingertip of the glove-style body.

According to an exemplary embodiment, the wearable input device further includes: a state switching module configured to control the wearable input device to switch between a standby state and a working state.

According to an exemplary embodiment, the state switching module is a pressure sensor.

An embodiment of the present disclosure provides an input method, including:

detecting whether a body performs a tap action on an operation plane;

determining a current position of the body on the operation plane; and

when it is determined that the body performs the tap action, sending the current position or a key value calculated according to the current position to a host.

According to an exemplary embodiment, when detecting whether the body performs a tap action on the operation plane, the method further includes:

determining whether the body has a position change in a direction perpendicular to the operation plane.

According to an exemplary embodiment, the method further includes:

after determining the current position of the body on the operation plane and before sending the current position or the key value calculated according to the current position to the host when it is determined that the body performs the tap action, determining whether the body performs the tap action according to a change of light signal and the position change of the body in the direction perpendicular to the operation plane.

An embodiment of the present disclosure provides a host. The host stores key positions and receives a current position transmitted by the wearable input device as described above to compare the current position with the key positions stored by the host to determine a key value.

An embodiment of the present disclosure provides an input method, including:

receiving a current position sent by a wearable input device; and

comparing the current position with stored key positions to determine a key value.

According to an exemplary embodiment, before the receiving the current position sent by the wearable input device, the method further includes:

storing a keyboard layout;

storing positions of initial keys; and

storing distances of individual keys from the initial keys.

An embodiment of the present disclosure provides an electronic system, including a host and a wearable input device. The host is the host as described, and the wearable input device is the wearable input device as described.

### BRIEF DESCRIPTION OF THE DRAWINGS

FIG. 1 is a schematic structural diagram of a wearable input device according to an embodiment of the present disclosure.

FIG. 2 is a schematic diagram showing connection relationships between components on a wearable input device according to an embodiment of the present disclosure.

FIG. 3 is a flowchart of an input method according to an embodiment of the present disclosure.

FIG. 4 is a flowchart of an input method according to an embodiment of the present disclosure.

FIGS. 5 and 6 are schematic diagrams showing position of keys according to an embodiment of the present disclosure.

### DETAILED DESCRIPTION

The exemplary embodiments of the wearable input device, the host, the input method, and the electronic system provided by the embodiments of the present disclosure are described in detail below with reference to the accompanying drawings. It should be noted that the embodiments described in the present specification are only a part of the embodiments of the present disclosure, and are not all of the embodiments. Embodiments of the present disclosure and features in the embodiments may be combined with each other if they are not conflict with each other. In addition, all other embodiments obtained by those skilled in the art based on the embodiments of the present disclosure fall within the scope of the present disclosure.

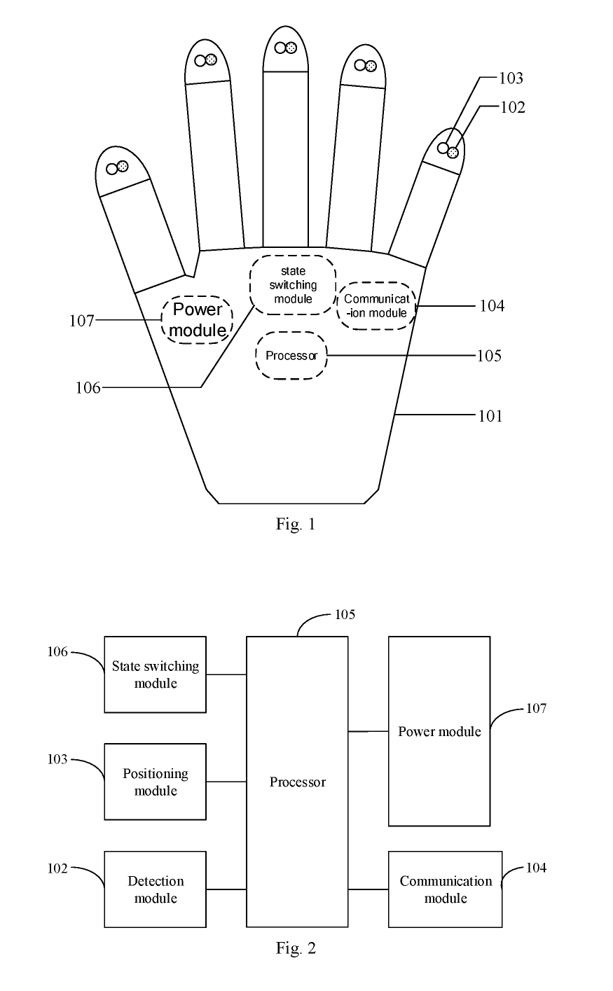

An embodiment of the present disclosure provides a wearable input device, as shown in FIGS. 1 and 2. The wearable input device includes a body 101, a detection module 102, a positioning module 103, a communication module 104, and a processor 105. The detection module 102, the positioning module 103, the communication module 104, and the processor 105 are provided on the body 101.

The detection module 102 is configured to detect whether the body 101 performs a tap action on an operation plane (for example, a horizontal plane), and send the detection result to the processor 105.

The positioning module 103 is configured to determine a current position (for example, coordinates in the horizontal direction X and the Y direction of the horizontal plane) of the body 101 on the operation plane, and send the current position to the processor 105.

The processor 105 is configured to send the current position or a key value calculated according to the current position to a host via the communication module 104 when the body 101 performs the tap action. That is, when the body 101 performs the tap action, the processor 105 can calculate the key value according to the current position, thereby realizing direct input of the key value on the host. Alternatively, the processor 105 sends the current position to the host, and then the host compares the current position with the key positions stored in the host to convert the current position into a corresponding key value, thereby implementing the input operation.

In the wearable input device provided by embodiments of the present disclosure, input operations can be performed in conjunction with the host (or collaboratively with the host) by merely four components, i.e., the detection module 102, the positioning module 103, the communication module 104 and the processor 105 which are arranged on the body 101, and thus the wearable input device has a simple structure, and is convenient to operate. Moreover, in practical applications, the wearable input device provided by the embodiments of the present disclosure can be operated on any plane such as a horizontal plane, a vertical plane or an inclined plane, and is not limited by the application scenarios.

In a specific implementation, in the above-mentioned wearable input device provided by the embodiments of the present disclosure, when the detection module 102 detects that the body 101 performs the tap action, the processor 105 sends the current position or the key value calculated according to the current position to the host via the communication module 104, so as to implement the input operations. In order to better determine that the body 101 performs the tap action and to prevent carelessness operations or inadvertent operations, in the above-mentioned wearable input device provided by the embodiments of the present disclosure, the positioning module 103 can also be used to determine whether the body 101 has a position change in a direction (e.g., in the Z direction) perpendicular to the operation plane, and send information regarding the position change to the processor 105.

The processor 105 is configured to, according to the detection result of the detection module 102 and the information regarding the position change, whether the body 101 performs the tap action, and when it is determined that the body 101 performs the tap action, send the current position or the key value calculated according to the current position to the host via the communication module 104.

That is, when the condition that detection module 102 detects that the body 101 performs the tap action, and the condition that the positioning module 103 determines that the position of the body 101 in the direction perpendicular to the operation plane changes are both satisfied, it can be determined that the body 101 does perform the tap action.

In a specific implementation, in the above-mentioned wearable input device provided by the embodiments of the present disclosure, the detection module 102 may be a light sensor, and may alternatively be other components known to those skilled in the art, such as a pressure sensor, and the present disclosure does not impose specific limitations on this.

For example, if the detection module 102 is a light sensor, the intensity of the light signal can be detected. In the situation where the body 101 does not contact the operation plane and the situation where the body 101 contacts the operation plane to perform the tap action, the light sensor can detect light signals of different intensities. Therefore, the light sensor can determine whether the body 101 performs a tap action on the operation plane according to the changes (e.g., changes in brightness of light) of the detected light signals.

Further, light signals of different intensities detected by the light sensor may only because the intensity of the ambient light itself has changed, while actually there is no key input operation. Under such situation, the light sensor may still send false information regarding a tap operation to the processor 105, thereby resulting in subsequent erroneous processes or operations. Moreover, the body 101 completes the tap action on the operation plane, its position in the direction perpendicular to the operation plane is inevitably changed, and thus it is more accurate for the determination of whether the body 101 performs the tap operation by considering the vertical position change. Preferably, while the light sensor detects the intensity of the light signal, the positioning module 103 detects the position change of the body 101 in the direction perpendicular to the operation plane, so that it is possible to determine whether the body 101 indeed performs the tap action according to the changes in light signals (e.g., changes in brightness) detected by the light sensor and the position change of the body 101 in the direction perpendicular to the operation plane as detected by the positioning module 103, thereby avoiding erroneous.

In a specific implementation, in the above-mentioned wearable input device provided by the embodiments of the present disclosure, the positioning module 103 may be a distance sensor, or other components, such as a photoelectric sensor, which are known to those skilled in the art. The present disclosure does not impose specific limitations on this.

For example, if the positioning module 103 is a distance sensor, it can be specifically used to obtain the distance of the body 101 from the initial position of the body 101 on the operation plane, and determine the current position of the body on the operation plane according to the distance.

In a specific implementation, in the above-mentioned wearable input device provided by the embodiment of the present disclosure, as shown in FIG. 1, the body 101 may be a glove-style body or a body of other forms or styles. For example, if the body 101 is a glove-style body, the detection module 102 and the positioning module 103 may be disposed at at least one fingertip on the palm side of the glove-style body in order to increase input accuracy. The communication module 104 and the processor 105 are disposed on the back side of the glove-style body.

It should be noted that, in the above-mentioned wearable input device provided by the embodiments of the present disclosure, both the detection module 102 and the positioning module 103 may be disposed on only one finger of the glove-style body. Alternatively, the detection module 102 and the positioning module 103 may be disposed on multiple fingers of the glove-style body. Specific settings can depend on habits of users. Generally, the detection module 102 and the positioning module 103 are disposed on the five fingers of the glove-style body, so that each finger can perform an input operation, which can improve work efficiency. In addition, the positioning module 103 and the detection module 102 may be disposed at the finger pulps for more accurate positioning. Of course, the positioning module 103 may also be disposed at a position on the back side which is opposite to a finger pulp. The present disclosure does not impose specific limitations on this. In addition, if the detection module 102 and the positioning module 103 are simultaneously disposed on the plurality of fingers of the glove-style body, the processor 105 sends the current position determined by the positioning module 103 on a finger where both the intensity of the light and the position in the direction perpendicular to the operation plane are both changed to the host via the communication module 104.

In addition, in the wearable input device provided by the embodiments of the present disclosure, in order to meet user habits and increase input efficiency, the glove-style body may include a left glove-style body and a right glove-style body, and the left glove-style body and the right glove-style body are mirror-symmetrical.

In a specific implementation, in the above wearable input device provided by the embodiments of the present disclosure, the communication module 104 may be for example a transmitter or a receiver or a transceiver in a wireless network following wireless protocols such as Bluetooth or 2G/3G/4G/5G/LAN (local area network), or may be components using other technologies known to those skilled in the art, and the present disclosure does not impose specific limitations on this.

In a specific implementation, the above-mentioned wearable input device provided by the embodiments of the present disclosure, as shown in FIGS. 1 and 2, the wearable input device may further include a state switching module 106 configured to control the processor to switch between a standby state and a working state. Specifically, the state switching module 106 can be a pressure sensor. After the wearable input device is worn by a user, the pressure sensor may sense squeezes, and the control processor 105 enters the working state at this time. After the user takes off the wearable input device, the pressure sensor senses no input signal, and the control processor 105 enters the standby state at this time. Of course, in specific applications, the switching between the standby state and the working state of the processor 105 can be controlled by other means such as a switch, which is not limited herein. In addition, the state switching module 106 can be disposed on the back side of the glove-style body, or can be disposed on the palm side of the glove-style body, or can be set according to actual needs, which is not limited herein.

In a specific implementation, the above-mentioned wearable input device provided by the embodiments of the present disclosure, as shown in FIGS. 1 and 2, may further include a power module 107 for supplying power to the processor 105. Specifically, the power module 107 can be a lithium battery or other component that can provide working energy, which is not limited herein. In addition, the power module 107 can be disposed on the back side of the glove-style body, or can be disposed on the palm side of the glove-style body, or can be set according to actual needs, which is not limited herein.

Based on the same inventive concept, an embodiment of the present disclosure provides an input method. The principle of the input method is similar to the principle that the wearable input device solves the problem. Therefore, details of the implementation of the input method provided by the embodiment of the present disclosure may be found in the descriptions regarding previous embodiments and repeated descriptions are omitted here.

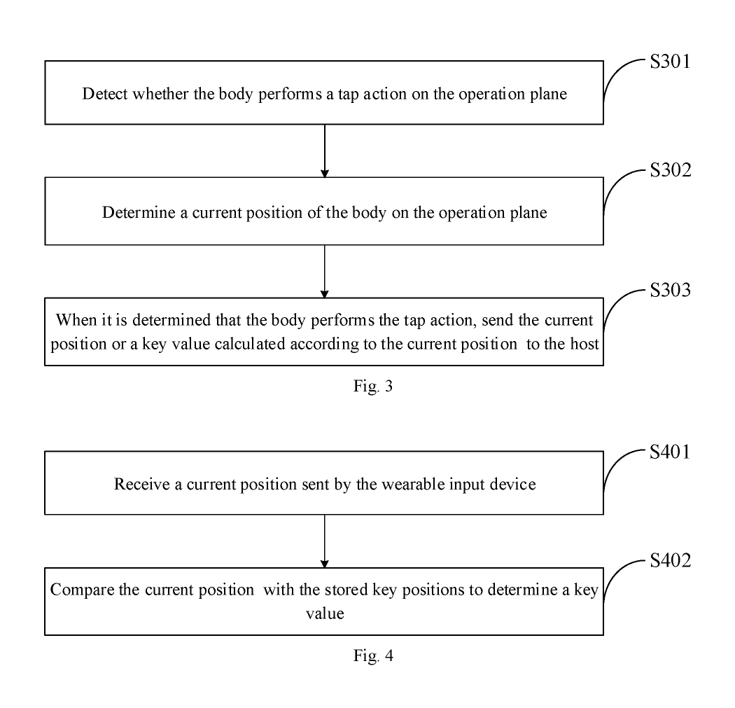

Specifically, as shown in FIG. 3, an input method provided by an embodiment of the present disclosure may include the following steps.

In S301, whether the body performs a tap action on the operation plane is detected.

In S302, a current position of the body on the operation plane is determined.

In S303, when it is determined that the body performs the tap action, the current position or a key value calculated according to the current position is sent to the host.

In a specific implementation, in order to more accurately determine whether the body performs a tap action on the operation plane, in the above input method provided by the embodiment of the present disclosure, in step S301, when detecting whether the body performs a tap action on the operation plane, the following step can be performed:

determining whether the body has a position change in a direction perpendicular to the operation plane.

Based on the above, in the above input method provided by the embodiment of the present disclosure, after determining the current position of the body on the operation plane in step S302 and before sending the current position or the key value calculated according to the current position to the host when it is determined that the body performs the tap action in step S303, the method may further include the following step:

determining whether the body performs the tap action according to a change of light signal and the position change of the body in the direction perpendicular to the operation plane

Correspondingly, an embodiment of the present disclosure further provides a host. The host stores key positions and receives a current position transmitted by the wearable input device to compare the current position with the key positions stored by the host to determine a key value.

It should be noted that the host in the above electronic system provided by the embodiments of the present disclosure may be an electronic product such as a notebook computer, a smart phone, or a PAD, and can communicate with the wearable input device by wireless networks such as Bluetooth or WIFI, or 2G/3G/4G/5G/LAN. In addition, the host in the electronic system provided by the embodiments of the present disclosure may also be a desktop computer. To implement communication between the host and the wearable input device, the host may further include a communication module configured to receive the current position or the key value sent from the wearable input device. Further, the communication module in the host can be for example a transmitter or a receiver or a transceiver in a wireless network following a wireless protocol such as Bluetooth or WiFi.

Based on the same inventive concept, an embodiment of the present disclosure provides an input method. The principle of the input method is similar to the principle of the host for solving the problem. Therefore, the details of the implementation of the input method provided by the embodiments of the present disclosure can be found in the descriptions regarding the previous embodiments, and the repeated descriptions are omitted here.

Specifically, as shown in FIG. 4, an input method provided by the embodiment of the present disclosure may specifically include the following steps:

In S401, a current position sent by the wearable input device is received.

In S402, the current position is compared against the stored key positions to determine a key value. For example, the distances between individual keys and initial keys (such as keys A, S and so on) are stored in the host, if the current position is received and the distance between the current position and one of the initial key (e.g., key A) matches the stored distance between key W and the key A, it can be determined the key which the user wishes to input is the key W and the key value of W can be determined.

In a specific implementation, in the foregoing input method provided by the embodiment of the present disclosure, before receiving the current position sent by the wearable input device in S401, the following steps may also be performed:

storing a keyboard layout;

storing positions of initial keys; and

storing distances of individual keys from the initial keys.

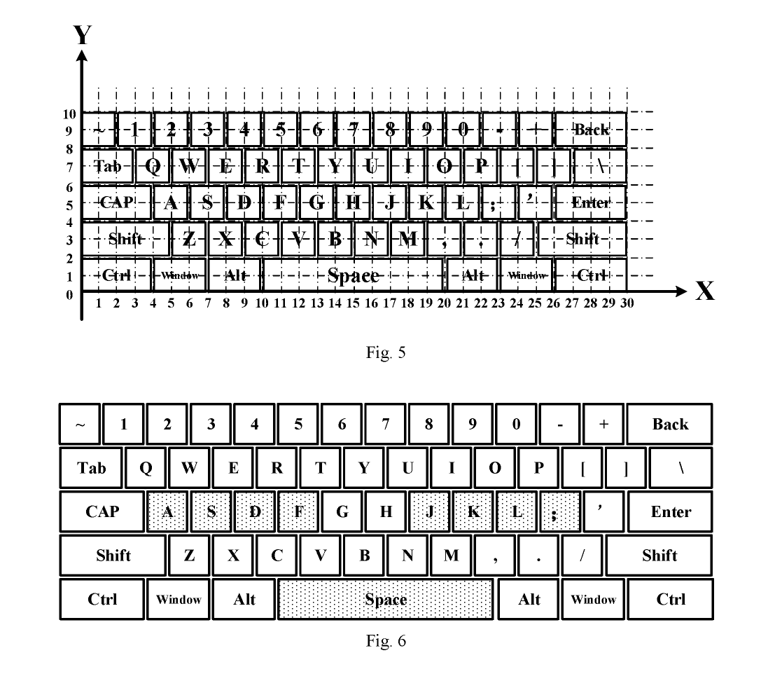

For example, FIG. 5 shows a layout of a standard keyboard, specifically showing positions of individual keys in the first quadrant of a two-dimensional coordinate system. The layout is stored in the host. As can be seen from the Figure, each key has a corresponding position. For example, the position range of the key “A” is x(4˜6) and y(4˜6), the position range of the key “B” is x(13˜15) and y(2˜4). Referring to FIG. 6, for the keyboard layout shown in FIG. 5, the positions of the shadow keys (the key A, the key S, the key D, the key F, the key J, the key K, the key L, the key; and the space key) can be stored in the host as the positions of initial keys. Also, distances between individual keys and the initial keys can be stored.

Of course, in actual applications, positions of keys arranged in the two-dimensional coordinate system arbitrarily can be stored to form a keyboard different from the standard keyboard layout shown in FIG. 5, so as to enable personalized settings of users. Moreover, in specific applications, the initial keys may be set without being limited to the above described initial keys, that is, the positions of the initial keys may be personalized according to users' preferences, and the present disclosure does not impose specific limitations on this.

It should be noted that if the pre-stored key positions are not changed in future usage, the storage step may be performed only before the first performing of the step of receiving the current position transmitted by the wearable input device in S401.

Based on the same inventive concept, an embodiment of the present disclosure further provides an electronic system including a host and a wearable input device. The host is the host as described in the above embodiments, and the wearable input device is the wearable input device as described in the above embodiments. The principle for the electronic system to solve the technical problem is similar to that of the above-mentioned host and the above-mentioned wearable input device. Details of the implementation of the electronic system provided by the embodiment of the present disclosure can be found in the descriptions regarding the previous embodiments and repeated descriptions are omitted here.

For a better understanding of the technical solutions of the present disclosure, the specific working process of the above-mentioned wearable input device, the host and the electronic system provided by the embodiments of the present disclosure will be described in detail below by using an example.

A keyboard layout conforming to habits of a user is stored in software of the host, and the positions of the initial keys and the distance of each of the keys as compared to the initial keys are configured.

When the user wears the wearable input device, the pressure sensor senses a pressure signal from the back of the hand, and the wearable input device enters the working mode from the standby mode, at which time the light sensor and the distance sensor start to work.

Specifically, the light sensor detects the light intensity at the fingertips on the glove-style body in real time, and sends the detected change in light intensity to the processor.

The distance sensor collects the distances between the fingertips on the operation plane and the initial positions of the fingertips in real time, determines whether there are changes in the positions of the fingertips in the direction perpendicular to the operation plane, and sends the current positions of the fingertips on the operation plane according to the distances and the changes in the positions of the fingertips in the direction perpendicular to the operation plane to the processor.

The processor sends the current position determined by the distance sensor on the finger where the light intensity and the positions of the fingertips in the direction perpendicular to the operation plane are both changed to the host via the communication module.

The host compares the received current position with each key position stored in the host, and enters a matching key value.

After use, the user takes off the wearable input device, and the pressure sensor senses no pressure signal, and the wearable input device enters the standby mode from the working mode.

It should be noted that in order to more accurately achieve the matching of the current position received by the host with the stored key positions, the positions of the keys stored in the host can be corrected by the wearable input device before the input operation.

Specifically, the user wears the wearable input device, and positions of the initial keys corresponding to each finger are stored in the software in the host.

According to the prompt of the host software, the user uses the usual finger(s) to tap all keys on the operation plane in turn, and the host records the distance of each key compared with the initial key(s) and saves the distance, thus completing the correction.

In the future usage, if the relative positions of individual keys are not changed, it is only necessary to perform the correction when the wearable input device is used for the first time. If the positions of keys cannot be accurately determined during the initial use, a picture of a paper keyboard can be drawn to prompt the user about the positions of the keys. After the user is familiar with the (input) operations, the user can enter text and other information under the blank plane.

Embodiments of the present disclosure provide a wearable input device, a host, an input method, and an electronic system. The wearable input device includes a body, and further includes a detection module, a positioning module, a communication module, and a processor which are disposed on the body. The detection module detects whether the body performs a tap action on an operation plane, and sends the detection result to the processor. The positioning module determines a current position of the body on the operation plane, and sends the current position to the processor. If it is determined that the body performs the tap action, the processor sends the current position or a key value calculated according to the current position to the host via the communication module. In the technical solutions, input operations can be performed in conjunction with the host (or collaboratively with the host) by merely four components, i.e., the detection module, the positioning module, the communication module and the processor which are arranged on the body, and thus the wearable input device has a simple structure, and is convenient to operate. In addition, the positions of the keys can be stored in the host according to users' preferences to conform to users' operation habits. Moreover, the wearable input device provided by the embodiments of the present disclosure can be operated on any plane such as a horizontal plane, a vertical plane or an inclined plane, and is not limited by the application scenarios.

It is to be understood that the above embodiments are merely exemplary embodiments provided to explain the principles of the present disclosure, but the present disclosure is not limited thereto. Various modifications and improvements can be made by those skilled in the art without departing from the spirit and scope of the disclosure, and such modifications and improvements also fall within the scope of the present disclosure.

What is claimed is:

1. A wearable input device, comprising
a body,
a detection module, a positioning module, a communication module, and a processor, all provided on the body,
wherein:
the detection module is configured to detect whether the body performs a tap action on an operation plane, and to send a detection result to the processor;
the positioning module is configured to determine a current position of the body on the operation plane, and to send the current position to the processor; and
the processor is configured to send the current position or a key value calculated according to the current position to a host via the communication module when the body performs the tap action.

2. The wearable input device of claim 1, wherein:
the positioning module is further configured to determine whether the body has a position change in a direction perpendicular to the operation plane, and to send information regarding the position change to the processor; and
the processor is configured to determine, according to the detection result of the detection module and the information regarding the position change, whether the body performs the tap action, and when it is determined that the body performs the tap action, to send the current position or the key value calculated according to the current position to the host via the communication module.

3. The wearable input device of claim 1, wherein the detection module is a light sensor.

4. The wearable input device of claim 1, wherein the positioning module is a distance sensor, and is configured to obtain a distance from the body to an initial position of the body on the operation plane and to determine the current position of the body on the operation plane according to the distance.

5. The wearable input device of claim 1, wherein the body is a glove-style body, and the detection module and the positioning module are disposed at at least one fingertip of the glove-style body.

6. The wearable input device of claim 1, further comprising: a state switching module configured to control the wearable input device to switch between a standby state and a working state.

7. The wearable input device of claim 6, wherein the state switching module is a pressure sensor.

8. An input method, comprising:
detecting whether a body performs a tap action on an operation plane;
determining a current position of the body on the operation plane; and
when it is determined that the body performs the tap action, sending the current position or a key value calculated according to the current position to a host.

9. The input method of claim 8, wherein when detecting whether the body performs a tap action on the operation plane, the method further comprises:
determining whether the body has a position change in a direction perpendicular to the operation plane.

10. The input method of claim 9, further comprising:
after determining the current position of the body on the operation plane and before sending the current position or the key value calculated according to the current position to the host when it is determined that the body performs the tap action, determining whether the body performs the tap action according to a change of light signal and the position change of the body in the direction perpendicular to the operation plane.

11. A host, wherein the host stores key positions and receives a current position transmitted by the wearable input device of claim 1 to compare the current position with the key positions stored by the host to determine a key value.

12. An input method, comprising:
receiving a current position sent by a wearable input device; and
comparing the current position with stored key positions to determine a key value.

13. The input method of claim 12, before the receiving the current position sent by the wearable input device, further comprising:
storing a keyboard layout;
storing positions of initial keys; and
storing distances of individual keys from the initial keys.
